(19) United States
(12) Patent Application Publication
(10) Pub. No.: US 2005/0037241 A1
(43) Pub. Date: Feb. 17, 2005

(54) Power source selector and controller for multiple battery power supply

(75) Inventors: Michael E. Schneider, Austin, TX (US); Jinrong Qian, Plano, TX (US); Sisan Shen, Plano, TX (US); Brett Etter, Stewartsville, NJ (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: Intersil Americas Inc., Milpitas, CA (US)

(21) Appl. No.: 10/642,091

(22) Filed: Aug. 15, 2003

(51) Int. Cl. H01M 16/00

(52) U.S. Cl. 429/9

(57) ABSTRACT

A multiple mode battery power supply contains first and second batteries, an external adapter port and a load port. The batteries are selectively connected to a node by way of associated power MOSFET switches. A power bus between the adapter port and the load port contains a MOSFET power switch. Finally a MOSFET power switch couples the node to the power bus. A controller selectively operates the power MOSFETS, to enable the load port to be powered by a selected one of any of an external adapter source of power, and one of the two batteries, while providing cross-conduction isolation among the external adapter source of power, and the batteries.

### FIELD OF THE INVENTION

The present invention relates in general to DC power supplies for portable electronic equipment, such as notebook computers and the like, and is particularly directed to a multimode DC power supply architecture that is operative to provide power from a selected one of a plurality of batteries, or from an external adapter input from which an auxiliary source of DC power is available, such as a 12 VDC automobile adapter, a 15-17 VDC aircraft adapter, or a 17-25 V AC adapter. The multimode power supply of the present invention is configured to perform this task without allowing the batteries to be charged by way of an external (aircraft) adapter, while still permitting the batteries to be charged from an AC-DC converter designed for the purpose.

### BACKGROUND OF THE INVENTION

Electrical power for operating a wide variety of electronic circuit-based products, such as portable and hand-held devices including notebook computers, personal digital assistants, and the like, is typically supplied by one or more direct current (DC) power sources, including rechargeable batteries. In an effort to meet the ongoing demand for longer run time of these battery-powered products, a number of enterprises, including equipment and service suppliers in the transportation industry, have begun offering their customers complimentary DC power adapters, that allow the user to derive power for an electronic device, such as a notebook computer, by way of an auxiliary DC power source adapter, such as may be provided in an automobile dashboard or in the armrest of an aircraft seat, as non-limiting examples.

The functionality of such auxiliary power adapters is to provide power for the electronic device being used, but not to charge the batteries of the device. To take advantage of such auxiliary power sources, the manufacturers of the electronic equipment have sought solutions the problem of automatically selectively steering the power source input to the device in question to the appropriate power source available, whether it be an external supply or one of a plurality of internal rechargeable batteries contained in the equipment.

### SUMMARY OF THE INVENTION

In accordance with the present invention this objective is successfully addressed by a new and improved, multimode DC power supply architecture that is configured as a highly integrated power source selector and controller for use with multiple (e.g., dual) battery notebook computers and other portable electronic equipment. As will be described, the controller directly supplies gate drive signals to power supply path devices, such as MOSFETs, to select from one of an external adapter or multiple battery sources to provide the power to the system load based on the presence of the power sources, the state of the batteries and commands from a host processor. The power supply steering mechanism of the present invention may be employed with any notebook battery charger for dual battery charging or may be used as a stand-alone power source selector.

The battery selector and its associated controller are operative to detect low battery conditions and check for the presence of battery by sensing battery voltage and using battery thermistor outputs. The invention provides inrush current limiting capability during adapter plug-in, and prevents cross-conduction during power source transition between adapter and battery. Inrush current is also eliminated during swapping between batteries, by providing a dead time control period to turn on and turn off external MOSFETs.

The invention features independent battery charging and discharging selections, which provide a solution to simplify the host interface logic design. It supports both aircraft power and automobile power applications, as it only provides the power to the system and prohibits battery charging therefrom. Moreover, the battery selector circuit of the present invention has a minimum number of external MOSFETs for reducing system cost. Also it provides the user with an independent programmable low battery threshold for different battery pack applications.

### BRIEF DESCRIPTION OF THE DRAWINGS

FIG. 1 diagrammatically illustrates the DC power supply architecture of the present invention;

FIG. 1A contains a truth Table 1 used for charging mode;

FIG. 1B contains a truth Table 2 used for aircraft power or automobile power operation;

FIG. 1C contains a truth Table 3 used for battery mode operation;

FIG. 2 contains a set of timing diagrams associated with Battery to AC Adapter transition;

FIG. 3 contains a set of timing diagrams for a transition of power from the number one battery to aircraft power transition;

FIG. 4 contains a set of timing diagrams associated with Adapter to Battery transition;

FIGS. 5A and 5B are timing diagrams associated with Battery to Battery switchover; and

FIG. 6 is a timing diagram associated with battery removal.

### DETAILED DESCRIPTION

Before describing a non-limiting, but preferred, embodiment of the multimode power supply architecture of the present invention, it should be observed that the invention resides primarily in an arrangement of conventional power supply circuit components, and the manner in which their operations may be selectively invoked by a digitally controller of the power supply system. It is to be understood that the invention may be embodied in a variety of other implementations, and should not be construed as being limited to only the embodiment shown and described herein. Rather, the implementation example shown and described here is intended to supply only those specifics that are pertinent to the present invention, so as not to obscure the disclosure with details that are readily apparent to one skilled in the art having the benefit of present description. Throughout the text and drawings like numbers refer to like parts.

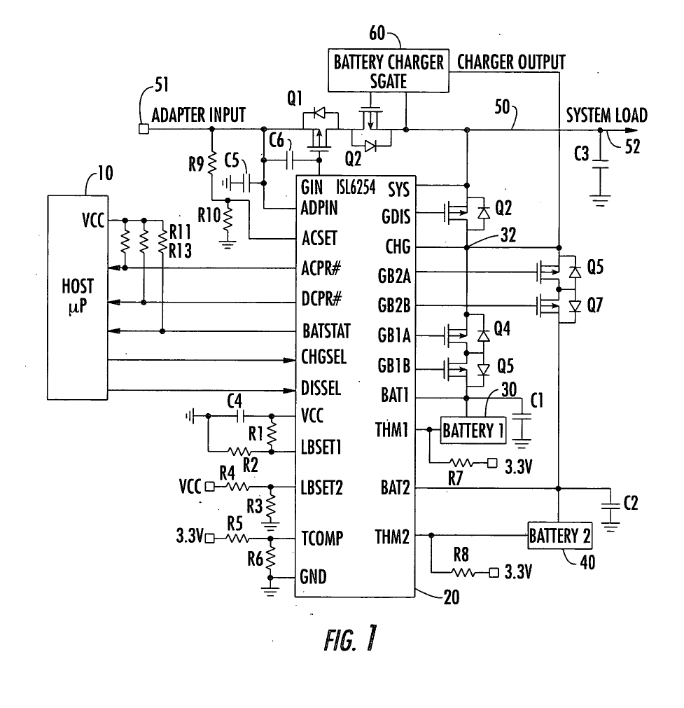

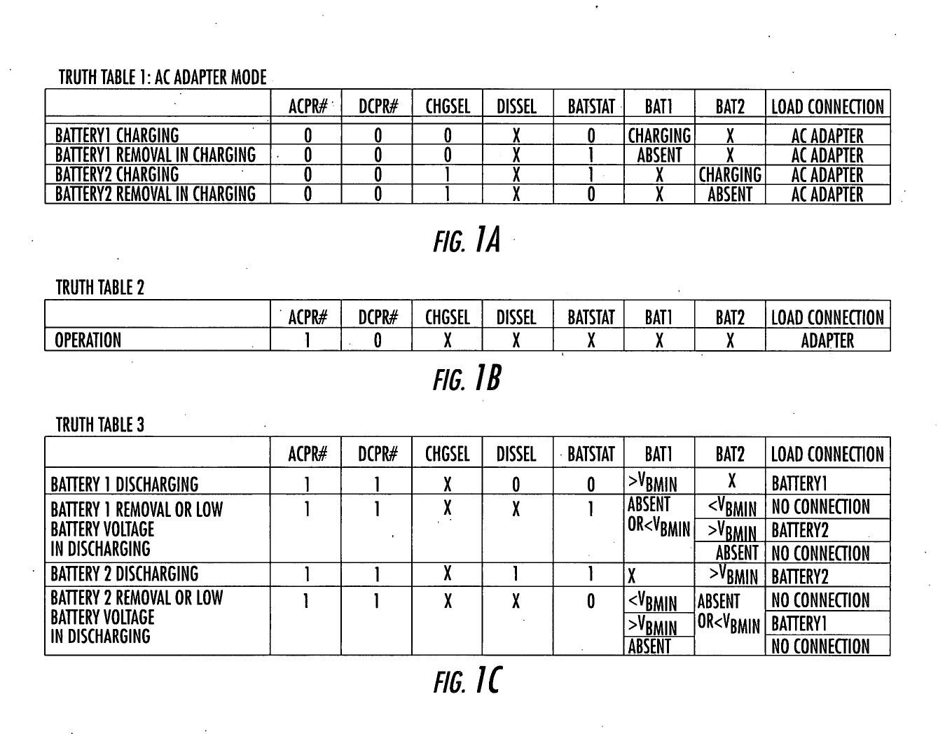

Attention is initially directed to FIG. 1, wherein the improved multimode DC power supply architecture of the invention is diagrammatically illustrated 1 as comprising a host processor 10 and an associated programmable logic array-based controller 20 that are operative to control the operation of various power supply path switching circuits, which selectively provide power from one of a plurality of battery packs 30 and 40 (two in the illustrated example) from an external DC supply adapter input 51, which provides external adapter connectivity to a main power bus 50, to which a powered load and a load reservoir capacitor C3 are connected.

The number one battery pack 30 is coupled to the controller 20 by way of a battery port BAT1, to which a reservoir capacitor C1 is coupled; a thermistor port THM1 is used by the controller 20 to monitor for the presence of a battery pack being actually physically installed in the battery retention slot for battery one. Similarly, the number two battery pack 40 is coupled to the controller 20 by way of a battery port BAT2, to which a reservoir capacitor C2 is coupled; a thermistor input THM2 is used to monitor for the presence of a battery pack being physically located in the battery installation slot for battery two.

The number one battery 30 is arranged to be controllably coupled to the main power bus 50 by way of pair of switching components, shown as power MOSFETs Q4 and Q5, having their source-drain paths connected in series such that their associated body diodes D4 and D5 are coupled back-to-back between battery 30 and a node 32. Orienting MOSFETs in a back-to-back arrangement ensures that one of their body diodes will be reversed biased at all times. MOSFETs Q4 and Q5 serve to isolate the number one battery path from each of the external adapter and the number two battery path, when the number one power source is providing power to the system load. Namely, MOSFETs Q4 and Q5 are used to prevent the number one battery 30 from shorting to the number two battery 40, when the number two battery 40 is connected to the system load as a result of the conduction of MOSFETs Q6 and Q7. This topology prevents cross-conduction between power sources and improves battery reliability. It also limits inrush current during power source transition by properly controlling the turn-on sequence of the corresponding MOSFETs. MOSFETs Q4 and Q5 have their respective gates coupled to control ports GB1A and GB1B of controller 20.

Node 32 is coupled to via source-drain current flow path of a power MOSFET Q2 to the main power bus 50, to a battery charger 60, and to a charge port CHG of the controller. The power MOSFET Q2 has its gate controlled via a GDIS port of the controller 20, while bus 30 is coupled to a system port SYS. In like manner, the number two battery 40 is coupled to the main power bus 50 by way of pair of power MOSFETs Q6 and Q7, having their source-drain paths connected in series such that their associated body diodes D6 and D7 are coupled back-to-back between battery 40 and node 32. MOSFETs Q6 and Q7 have their respective gates coupled to control ports GB2A and GB2B of controller 20. In a manner complementary to MOSFETs Q4 and Q5, described above, MOSFETs Q6 and Q7 serve to isolate the number two battery path from each of the external adapter and the number one battery path other when the number two power source provides power to the system load. Namely, MOSFETs Q6 and Q7 are used to prevent the number two battery 40 from shorting to the number one battery 30, when the number one battery 30 is connected to the system load as a result of the conduction of MOSFETs Q4 and Q5.

The main power bus further includes a power MOSFET Q1 and a power MOSFET Q3 having their source-drain current flow paths connected in series between the external adapter port 51 and a system load port 52. MOSFETs Q1 and Q2 are connected so that their body-diodes are connected in a back-to-back arrangement. The gate drive for MOSFET Q3 is provided by battery charger circuit 60, while the gate drive for MOSFET Q1 is provided by the GIN port of controller 20. A grounded capacitor C5 is coupled to the main power bus 50 and an ADPIN port of the controller. A capacitor C6 is coupled between the ADPIN port and the GIN port of the controller 20. A resistor divider comprised of resistors R9 and R10 is coupled between power bus 50 and an ACSET port of controller 20.

The ACSET port is used to sense the AC adapter voltage and its output AC adapter presence ACPR# pin tells the control processor 10 that the AC adapter voltage is high enough to charge the battery. The controller 20 senses the DC adapter or a DC input voltage with a prescribed threshold (e.g., 10.5V) and its output DC presence port DCPR# tells the processor 10 that DC input voltage is available to provide the power to the system load, but it is not ready to charge the battery. A charge select port CHGSEL and a discharge select port DISSEL are controllably driven from the processor 10. The CHGSEL port is used to specify which battery is to be charged, when in charging mode. The port DISSEL is used to specify which battery is to be used for system power, when in battery operation mode. A battery status port BATSTAT is used to advise the control processor that the selected battery is not installed, and that the other battery is being connected to the system bus (as long as its battery voltage is higher than the minimum operating voltage).

The controller 20 is able to set low battery minimum operating voltage for both the number one battery 30 and the number two battery 40 through ports LBSET1 and LBSET2, respectively. It disconnects the battery when its voltage is below the minimum battery operating voltage.

Operation

AC Adapter Mode

In this mode, the battery selector/control logic 20 checks for the presence of the AC adapter being coupled to main power bus port 51 by sensing the voltage at the ACSET port. An AC adapter is determined to be coupled to adapter input 51 of the main power bus, when the voltage at the ACSET port is higher than a prescribed threshold (e.g., 1.6 V). Port ACPR# provides an open drain output signal to inform the host processor 10 that the AC adapter is ready to charge the selected battery.

Charging Mode

In charging mode, the battery selector will charge either battery 1 (30) or battery 2 (40) according to the input status of port CHGSEL. If the CHGSEL is at a first logic level (e.g., 0), the number one battery (battery1) 30 is selected to be charged and MOSFETs Q4 and Q5 are turned on. On the other hand, if the CHGSEL is at a second logic level (e.g., 1), the number two battery (battery2) 40 is selected to be charged and MOSFETs Q6 and Q7 are turned on. During charging mode, MOSFET Q2 is off, so as to isolate the batteries from the main power bus 50 and the AC adapter. Table 1 in FIG. 1A, contains a truth table used for charging mode.

Aircraft Power or Automobile Power Operation Mode

As noted earlier, while the present invention is able to support aircraft power (15 V+/−1 V) and automobile (12 V+/−1 V) applications, aircraft power or automobile power is used only to provide system power, not to charge the battery. For this purpose, MOSFET Q1 is gradually turned on through the body diode D3 of MOSFET Q3 and supplies the power over the system power bus 50 to the system load. MOSFET Q3 is driven by the battery charger and is turned on to reduce the power dissipation. Table 2 in FIG. 1B, contains a truth table used for aircraft power or automobile power operation.

Battery Mode

In this mode of operation, there is no AC or DC adapter power provided, so that the ports ACPR# and DCPR# are set equal to a logical 1. The processor selects the battery to be used to provide system power according to the logical value applied to the port DISSEL. FIG. 1C contains a truth Table 3 used for battery mode operation. As long as the selected battery voltage is above a prescribed minimum operating voltage, that battery will be connected to the system bus according to the state of the DISSEL port.

Battery Removal or Low Battery Voltage in Discharge

If the selected battery is not installed, or its output voltage is below the minimum battery operating voltage, the other battery will be connected to the system bus, as long as its battery voltage is higher than the minimum operating voltage, while providing a battery status signal to the control processor. Otherwise, no battery is connected to the system bus.

Power Source Transition Made

The general requirements for power source transitions are to avoid cross-conduction among the power sources and to avoid producing an inrush current to charge the capacitor across the system bus from battery voltage to AC adapter voltage.

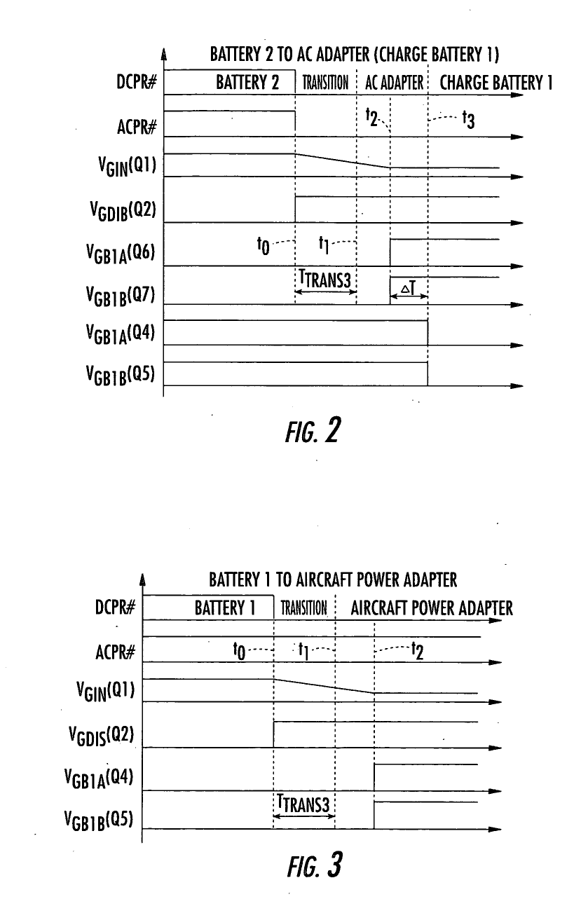

Battery to AC Adapter Transition (FIG. 2)

In the present description, it will initially be assumed that power is being applied to the system power bus by way of the number two battery 40. With attention the timing diagrams of FIG. 2, a logical high level represents an OFF state, while a logical low level represents an ON state of the device of interest. The following description equally applies to the case of initially supplying power from battery number one, with a change in MOSFET pairs (Q4, Q5) for (Q6, Q7) and (Q6, Q7) for (Q4, Q5).

Thus, in the present example of initially supplying power from the number two battery 40, prior to a transition time t0, logical highs are applied to MOSFETs Q1, Q4 and Q5, so that these devices are off, while logical lows are applied to MOSFETs Q2, Q6 and Q7, so that these devices are on. With each of MOSFETs Q2, Q6 and Q7 being on, power is being supplied to the system power bus 50 from battery number two (40), as described above. A logical high is also asserted by each of the DCPR# and ACPR# ports. As pointed out above, when ports ACPR# and DCPR# are set equal to a logical 1 (prior to time t0 in FIG. 2), no AC or DC adapter power is being provided.

At an initial transition time t0, each of ports ACPR# and DCPR# are set equal to a logical 0, corresponding to a transition from battery to adapter mode. In addition, the voltage at the GDIS port is asserted high to a logical 1, causing MOSFET Q2 to turn off. This is followed by a gradual turn on of MOSFET Q1. Turning off MOSFET Q2 first and then allowing MOSFET Q1 to be slowly turned on serves to prevent the generation of an inrush current in the course of making a battery to AC adapter transition. It should be noted that the body-diode D2 of the discharging MOSFET Q2 conducts before the AC adapter fully provides the power to the system. Once the bus voltage becomes higher than the battery voltage, the body-diode of MOSFET Q2 is naturally turned off. MOSFET Q1 becomes turned on at time t1, to complete a transition interval time from time t0 to time t1.

The two back-to-back MOSFETs Q4 and Q5 cannot turn on simultaneously, so as to avoid cross-conduction between two batteries. Once the input to MOSFET Q1 is reduced to its lowest logical state at time t2, so that it is fully turned on, the two back-to-back MOSFETs Q6 and Q7 are turned off, as shown by the low-to-high transitions at time t2. After a prescribed delay time of ΔT, the number one battery 30 is turned on so that it can be charged through node 32 to the battery charger. Battery 30 is isolated from the power bus, since MOSFET Q2 is off.

Battery to Aircraft Power Adapter (FIG. 3)

FIG. 3 shows timing diagrams for a transition of power from the number one battery 30 to aircraft power transition. In the present example, it will be assumed that power is initially being supplied from the number one battery 30, so that prior to a transition time t0, a logical high is applied to MOSFET Q1, so that this device is off and the adapter to system load path is interrupted, while logical lows are applied to MOSFETs Q2, Q4 and Q5, so that these devices are on. With each of MOSFETs Q2, Q4 and Q5 being on, power is being supplied to the system power bus 50 from the number one battery 30. A logical high is also asserted by each of the DCPR# and ACPR# ports. Again, as pointed out above, when ports ACPR# and DCPR# are set equal to a logical 1 (prior to time t0 in FIG. 2), no AC or DC adapter power is being provided.

At an initial transition time t0, port DCPR# is set equal to a logical 0, corresponding to a transition from battery to aircraft adapter mode. In addition, the voltage at the GDIS port is asserted high to a logical 1, causing MOSFET Q2 to turn off. Again, as described above, this is followed by a gradual turn on of MOSFET Q1, to prevent the generation of an inrush current in the course of making a battery to adapter transition. MOSFET Q1 becomes turned on at time t1, to complete a transition interval time from time t0 to time t1. Once the input to MOSFET Q1 is reduced to its lowest logical state at time t2, so that it is fully turned on, the two back-to-back MOSFETs Q4 and Q5 are turned off, as shown by the low-to-high transitions at time t2.

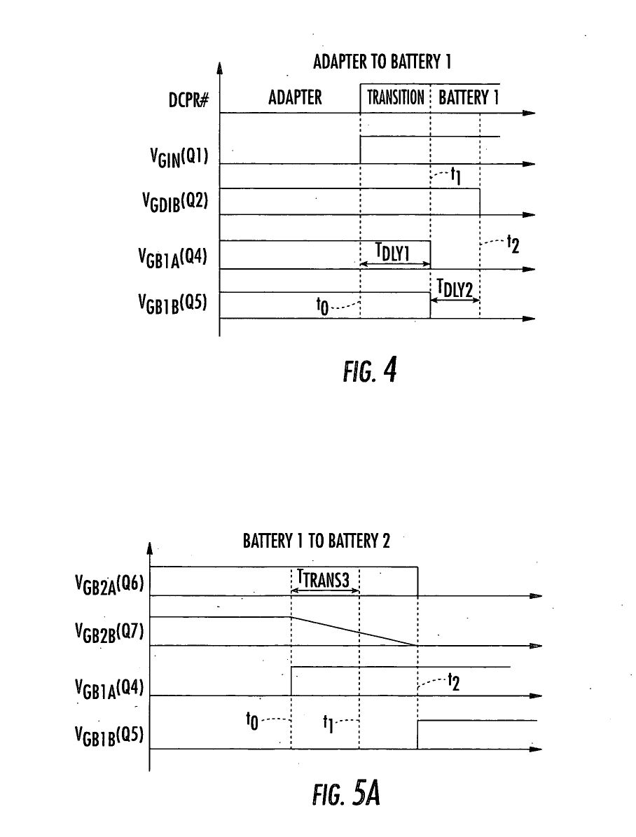

Adapter to Battery (FIG. 4)

When the connection to the adapter is removed, it is necessary to turn on one the back-back pairs of MOSFETs (either MOSFETs Q4 and Q5 or MOSFETs Q6 and Q7) in accordance with the state of the DISSEL port after a prescribed delay (e.g., 5-10 μs) when adapter power is not available. In order to reduce the inrush current to the battery, the discharging MOSFET Q2 is turned on after a predetermined transition interval (e.g., on the order of 10 μs) when either MOSFET pair (Q4 and Q5) or (Q6 and Q7) are turned on. More particularly, prior to a transition time t0, a logical low is applied to MOSFET Q1, so that this device is on, so the adapter to system load path is closed, while logical highs are applied to MOSFETs Q2, Q4 and Q5, so that these devices are off. With each of MOSFETs Q2, Q4 and Q5 being off, power is being supplied to the system power bus 50 from the adapter. A logical low is also asserted by the DCPR# port. As noted above, with port DCPR# set equal to a logical 0 (prior to time t0 in FIG. 4), adapter power is being provided.

At an initial transition time t0, port DCPR# is set equal to a logical 1, corresponding to a transition from adapter to battery power. In addition, the voltage at the GIN port is asserted high to a logical 1, causing MOSFET Q1 to turn off, thereby interrupting the power supply path to the load from the adapter. After a prescribed delay period T_{DLY1}, MOSFETs Q4 and Q5 are turned on at time t1, followed by a subsequent delay period T_{DLY2}, at which time t2, the discharging MOSFET Q2 is turned on. As pointed out above, to reduce the inrush current to the battery, MOSFET Q2 is turned on after a predetermined transition interval (e.g., on the order of 10 μs) subsequent to turning on either MOSFET pair (Q4 and Q5 in the present example).

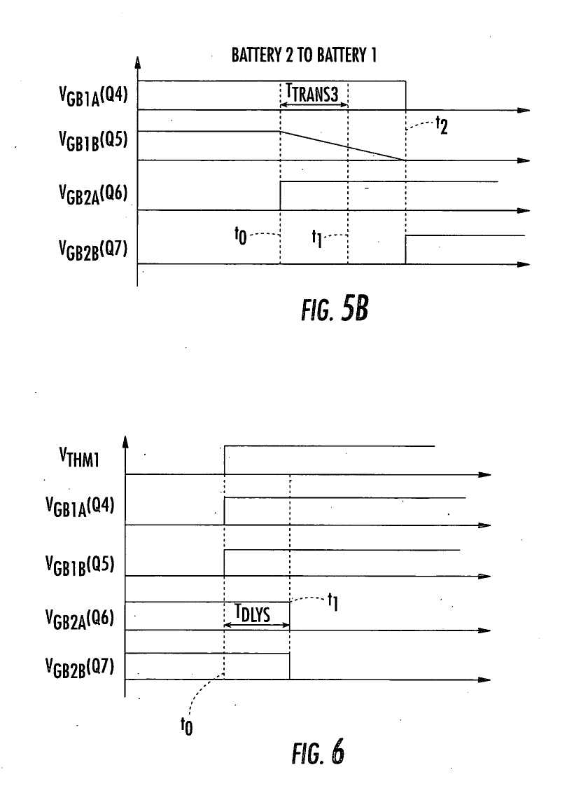

Battery to Battery (FIGS. 5A, 5B)

Battery to battery switchover happens during both charging and battery discharging. But the control method is the same. FIG. 5A shows switching waveforms for battery switchover from the number one battery 30 to the number two battery 40, while FIG. 5B shows switching waveforms for battery switchover from the number two battery 40 to the number one battery 30, battery based on DISSEL and CHGSEL and battery operating conditions. As noted above, the CHGSEL port is used to specify which battery is to be charged, when in charging mode, while the port DISSEL is used to specify which battery is to be used for system power, when in battery operation mode.

Prior to time t0, with power being supplied to the system bus 50 from battery 30, its associated MOSFET pair Q4 and Q5 are initially turned on, while MOSFET pair Q6 and Q7, associated with battery 40 are turned off. At time t0 MOSFET Q4 is turned off, to interrupt the conductive path between battery 30 and the system bus 50. At the same time MOSFET Q6 is turned on, MOSFET Q7 is turned on gradually from t0 to t1. Subsequently, at time t2, MOSFET Q5 is turned off, and MOSFET Q6 is turned on so that both MOSFETs Q4 and Q5 are fully turned off, and MOSFETs Q6 and Q7 are fully turned on, which is the reverse of the battery path connection condition prior to t0. Namely, system bus power is now provided exclusively from battery 40.

The situation in FIG. 5B is the reverse of that shown in FIG. 5A described above. Namely, prior to time t0, with power being supplied to the system bus 50 from battery 40, its associated MOSFET pair Q6 and Q7 are initially turned on, while MOSFET pair Q4 and Q5, associated with battery 30 are turned off. At time t0 MOSFET Q6 is turned off, to interrupt the conductive path between battery 40 and the system bus 50. MOSFET Q5 is turned on gradually from t0 to t1. Subsequently, at time t2, MOSFET Q7 is turned off, and MOSFET Q4 is turned on, so that both MOSFETs Q6 and Q7 are fully turned off, and MOSFETs Q4 and Q5 are fully turned on, which is the reverse of the battery path connection condition prior to t0. Namely, system bus power is now provided exclusively from battery 30.

Battery Removal (FIG. 6)

As pointed out previously, each battery slot has an associated thermistor port THM that is used by the controller to monitor for the presence of a battery pack being physically located in the battery installation slot for that battery one. FIG. 6 shows the situation for the removal of the number one battery 30. When battery 30 is removed, in response to the thermistor port THM1 transitioning low to high, the controller responds by turning of MOSFETs Q4 and Q5 at time t0. Then after a prescribed delay T_{DLY3} (on the order of 5-10 microseconds), it turns on MOSFETs Q6 and Q7, at time t1, as long as the voltage of the number two battery 40 is above the minimum operating voltage. Therefore, even the thermistor pin is disconnected first, while the battery input pin is disconnected later, there is no cross conduction. If the battery input pin is disconnected first while the thermistor pin is disconnected later, the capacitor in parallel with this battery is discharged until the voltage is below to the minimum operating voltage. The controller then switches to the other battery if the other battery voltage is above the minimum operating voltage.

Battery Start-up

There are no communications between host and battery selector before notebook computer start-up because there is no system power rail voltage (3.3 V, 5 V) available. If no adapter is available, one battery pack has to be connected to the system bus through the discharging path. The battery selector is always alive as long as one of the three power sources is available. If there is no command from the host processor, the DISSEL pin will be pulled down and automatically select the number one battery 30 as a primary default battery to start up the system. If the primary battery is absent or its voltage is below the minimum battery operating voltage set by LBSET1, then the controller will switch over to the secondary battery 40 by turning on MOSFETs Q2, Q6 and Q7, as described above. Therefore, system bus power is always available if one of three power sources is available.

While we have shown and described an embodiment in accordance with the present invention, it is to be understood that the same is not limited thereto but is susceptible to numerous changes and modifications as known to a person skilled in the art. We therefore do not wish to be limited to the details shown and described herein, but intend to cover all such changes and modifications as are obvious to one of ordinary skill in the art.

1. A multiple mode battery power supply comprising:
a first battery installation location configured to retain therein a first battery, and being selectively coupled through a first controlled switching path to a first node;
a second battery installation location configured to retain therein a second battery, and being selectively coupled through a second controlled switching path to said first node;
a power bus coupled between a power adapter port and a load port, said power bus including a third controlled switching path selectively coupled between said power adapter port and said load port;
a fourth controlled switching path selectively coupled between said first node and said load port; and
a controller which controllably operates said first, second, third and fourth controlled switching paths, so as to enable said load port to be powered by a selected one of any of an external adapter source of power, and said first and second batteries, while providing cross-conduction isolation among said external adapter source of power, and said first and second batteries.

2. The multiple mode battery power supply according to claim 1, wherein said controlled switching paths comprise MOSFET switching devices.

3. The multiple mode battery power supply according to claim 1, wherein said controlled switching paths contain no more than seven MOSFET switching devices.

4. The multiple mode battery power supply according to claim 1, wherein each of said first and second controlled switching paths comprises a respective pair of MOSFET switching devices having body diodes thereof connected back-to-back.

5. The multiple mode battery power supply according to claim 1, wherein said third controlled switching path comprises a pair of MOSFET switching devices having body diodes thereof connected back-to-back.

6. The multiple mode battery power supply according to claim 1, wherein, for adapter mode of operation, said controller is operative to selectively close said third controlled switching path, while opening said first, second and fourth controlled switching paths, so as to provide power from said power adapter port over said power bus to said load port.

7. The multiple mode battery power supply according to claim 1, wherein, for battery mode of operation, said controller is operative to selectively close said fourth controlled switching path and one of said first and second controlled switching paths, while opening the other of said first and second controlled switching paths and said third controlled switching path.

8. The multiple mode battery power supply according to claim 1, wherein, for transitioning from battery mode of operation to adapter mode of operation, said controller is operative to open said fourth controlled switching path and gradually close said third controlled switching path, and thereafter open whichever one of said first and second controlled switching paths had been supplying battery power to said power bus.

9. The multiple mode battery power supply according to claim 8, further including a battery charging unit coupled to said first node, and wherein said controller is further operative to close whichever other of said first and second controlled switching paths had not been supplying battery power to said power bus, so as to place an associated battery in communication with said first node and thereby enable charging of said associated battery from said battery charging unit through said whichever other of said first and second controlled switching paths.

10. The multiple mode battery power supply according to claim 1, wherein, for transitioning from battery mode of operation to vehicle supply mode of operation, said controller is operative to open said fourth controlled switching path and gradually close said third controlled switching path, and thereafter open whichever one of said first and second controlled switching paths had been supplying battery power to said power bus, so as to connect said load port to said power adapter port.

11. The multiple mode battery power supply according to claim 10, wherein said controller is further operative to open whichever of said first and second controlled switching paths had been supplying battery power to said power bus, so as to prevent an associated battery from being placed in communication with said first node and thereby prevent charging of said associated battery from a battery charging unit connected to said first node.

12. The multiple mode battery power supply according to claim 1, wherein, for transitioning from adapter mode of operation to battery mode of operation, said controller is operative to open said third controlled switching path and thereafter close one of said first and second controlled switching paths and said fourth controlled switching path.

13. The multiple mode battery power supply according to claim 12, wherein said controller is operative to close said one of said first and second controlled switching paths and thereafter close said fourth controlled switching path so as to prevent flow of inrush current to the battery associated with the selected path.

14. The multiple mode battery power supply according to claim 1, wherein, for transitioning from one battery to another, said controller is operative to close one of said first and second controlled switching paths and open the other of said first and second controlled switching paths in a manner that prevents a flow of inrush current between batteries of said first and second controlled switching paths.

15. The multiple mode battery power supply according to claim 1, wherein, in response to removal of a battery, said controller is operative to open that one of said first and second controlled switching paths associated with the removed battery and, after a prescribed delay, to close the other of said first and second controlled switching paths associated with an operative battery that has not been removed.

16. A method of controllably supplying power to a power supply port comprising the steps of:
(a) coupling a first battery through a first controlled switching path to a first node;
(b) coupling a second battery through a second controlled switching path to said first node;
(c) coupling a power adapter port to a load port through a third controlled switching path;
(d) coupling said first node to said load port through a fourth controlled switching path; and
(e) selectively operating said first, second, third and fourth controlled switching paths, so as to enable said load port to be powered by a selected one of any of an external adapter source of power, and said first and second batteries, while providing cross-conduction isolation among said external adapter source of power, and said first and second batteries.

17. The method according to claim 15, wherein said controlled switching paths comprise MOSFET switching devices.

18. The method according to claim 15, wherein said controlled switching paths contain no more than seven MOSFET switching devices.

19. The method according to claim 16, wherein each of said first and second controlled switching paths comprises a respective pair of MOSFET switching devices having body diodes thereof connected back-to-back.

20. The method according to claim 16, wherein said third controlled switching path comprises a pair of MOSFET switching devices having body diodes thereof connected back-to-back.

21. The method according to claim 16, wherein step (e) comprises effecting adapter mode of operation by selectively closing said third controlled switching path, while opening said first, second and fourth controlled switching paths, so as to provide power from said power adapter port over said power bus to said load port.

22. The method according to claim 16, wherein step (e) comprises effecting battery mode of operation, by selectively closing said fourth controlled switching path and one of said first and second controlled switching paths, while opening the other of said first and second controlled switching paths and said third controlled switching path.

23. The method according to claim 16, wherein step (e) comprises transitioning from battery mode of operation to adapter mode of operation, by opening said fourth controlled switching path and gradually closing said third controlled switching path, and thereafter opening whichever one of said first and second controlled switching paths had been supplying battery power to said power bus.

24. The method according to claim 23, further including coupling a battery charging unit to said first node, and wherein step (e) further comprises closing whichever other of said first and second controlled switching paths had not been supplying battery power to said power bus, so as to place an associated battery in communication with said first node and thereby enable charging of said associated battery from said battery charging unit through said whichever other of said first and second controlled switching paths.

25. The method according to claim 16, wherein step (e) comprises transitioning from battery mode of operation to vehicle supply mode of operation, by opening said fourth controlled switching path and gradually closing said third controlled switching path, and thereafter opening whichever one of said first and second controlled switching paths had been supplying battery power to said power bus, so as to connect said load port to said power adapter port.

26. The method according to claim 25, wherein step (e) further comprises opening whichever of said first and second controlled switching paths had been supplying battery power to said power bus, so as to prevent an associated battery from being placed in communication with said first node and thereby prevent charging of said associated battery from a battery charging unit connected to said first node.

27. The method according to claim 16, wherein, step (e) comprises transitioning from adapter mode of operation to battery mode of operation, by opening said third controlled switching path and thereafter closing one of said first and second controlled switching paths and said fourth controlled switching path.

28. The method according to claim 27, wherein step (e) further comprises closing said one of said first and second controlled switching paths and thereafter closing said fourth controlled switching path so as to prevent flow of inrush current to the battery associated with the selected path.

29. The method according to claim 16, wherein step (e) comprises transitioning from one battery to another, by closing one of said first and second controlled switching paths and opening the other of said first and second controlled switching paths in a manner that prevents a flow of inrush current between batteries of said first and second controlled switching paths.

30. The method according to claim 16, wherein step (e) comprises, in response to removal of a battery, opening that one of said first and second controlled switching paths associated with the removed battery and, after a prescribed delay, closing the other of said first and second controlled switching paths associated with an operative battery that has not been removed.
